(19) United States
(12) Patent Application Publication
(10) Pub. No.: US 2026/0236258 A1
(43) Pub. Date: Aug. 13, 2026

(54) SYSTEMS AND METHODS OF VARIABLE EXTRACTION AND MAPPING FOR PROGRAMMABLE CONTROLLERS

(71) Applicant: H2OK Innovations Inc., Somerville, MA (US)

(72) Inventors: David LU, Boston, MA (US); Annie LU, Boston, MA (US); Hu DOU, Chelmsford, MA (US); Edward Jitong LIU, Somerville, MA (US)

(73) Assignee: H2OK Innovations Inc., Somerville, MA (US)

(21) Appl. No.: 19/531,832

(22) Filed: Feb. 6, 2026

Related U.S. Application Data
(60) Provisional application No. 63/757,143, filed on Feb. 11, 2025.

(51) Int. Cl. G06F 9/30; G06F 16/25

(52) U.S. Cl. CPC G06F 9/30043; G06F 16/254

(57) ABSTRACT

Variable extraction and mapping for programmable controllers is provided. An example method includes requesting, by a device remote from the programmable controller, a transfer to and storage in a memory of the device, of the instructions configured for effective use of the programmable controller. The method can include transferring and storing of such instructions into the memory. The method can include ingesting the instructions and a predefined set of reference variables into a model to generate a mapping between variables of the instructions and the predefined set of reference variables. The method can include using the mapping to adjust the instructions to operate based on an interface with a control mechanism. The method can include transferring control of the programmable controller to the updated instructions by transferring the updated instructions to the programmable controller.

### CROSS REFERENCE TO RELATED APPLICATIONS

This application claims the benefit of, and priority to, U.S. Provisional Patent Application No. 63/757,143 filed Feb. 11, 2025, the entirety of which is incorporated by reference herein.

### BACKGROUND

Codebases can use various standardized conventions, or eschew any standard whatsoever. For example, a codebase can include textual or graphical languages having named variables.

### SUMMARY OF THE INVENTION

At least one aspect is directed to a method for extraction, transformation, and loading (ETL) of instructions of a programmable controller. The method can include requesting, by a device remote from the programmable controller, a transfer to and storage in a memory of the device, of the instructions configured for effective use of the programmable controller. The method can include transferring and storing of such instructions into the memory. The method can include ingesting the instructions into a model to generate a mapping between variables of the instructions and a description of their function. The method can include using the mapping to adjust the instructions to operate based on an interface with a control mechanism. The method can include transferring control of the programmable controller to the updated instructions by transferring the updated instructions to the programmable controller.

At least one aspect is directed to a system for extraction, transformation, and loading of instructions of a programmable controller. The system includes one or more processors coupled with memory. The one or more processors can request a transfer to and storage of the instructions into a memory of a device. The one or more processors can transfer and store the instructions into the memory. The one or more processors can ingest the instructions to generate a mapping between variables of the instructions and a description of their function. The one or more processors can use the mapping to adjust the instructions to operate based on an interface with a control mechanism. The one or more processors can transfer control of the programmable controller to the updated instructions by transferring the updated instructions to the programmable controller.

At least one aspect is directed to a non-transitory computer readable medium, including one or more instructions stored thereon and executable by a processor. The instructions include instructions to request a transfer to and storage of the instructions into a memory of a device. The instructions include instructions to transfer and store the instructions into the memory. The instructions include instructions to ingest the instructions and a predefined set of reference variables into a model to generate a mapping between variables of the instructions and the predefined set of reference variables. The instructions include instructions to use the mapping to adjust the instructions to operate based on an interface with a control mechanism. The instructions include instructions to transfer control of a programmable controller to the updated instructions by transferring the updated instructions to the programmable controller.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example data processing system, in accordance with some aspects;

FIG. 2 depicts a dataflow for the data processing system of FIG. 1, in accordance with some aspects;

FIG. 3 depicts a dataflow for an example method, in accordance with some aspects;

FIG. 4 depicts an example of a graphical user interface, in accordance with some aspects;

FIG. 5 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of variable extraction and mapping for programmable controllers. The various concepts introduced above and discussed in greater detail below can be implemented in any of numerous ways.

Chemical processes related to beverages, pharmaceutical products, or beauty products can operate according to batched or continuous flow processes. Production equipment for liquid components or products can include computational systems to interface with various controls or sensors to implement process controls. For example, a programmable logic controller (PLC) of the computational system can interface with various controls and sensors. The sensors can include pressure sensors, temperature sensors, or inline spectral sensors, for example. The controls can include valves, switches, motors, conveyor belts, or other actuators used to implement various processes performed according to sensor data of the sensors. For example, the actuation of the controls can correspond to washing, rinsing, mixing, heating, purging, pressurizing, or sterilizing operations, among others. The programmable logic controller can include instructions to actuate the controls based on sensor data received from the sensors, predefined durations, or other inputs (e.g., inputs to a human-machine interface) to implement industrial fluidic processes. Industrial fluidic processes can refer to or include any of various processes using a fluid as a component of an output, or as a cleaning, cleaning-in-place, rinsing, or other agent used according to a process to generate the output. For example, industrial fluidic processes include processes used to manufacture consumer packaged goods, health and beauty goods, dairy products, and brewery products.

A data processing system can adjust instructions of the PLC to improve process controls. The adjustments to the instructions can include instructions to adjust cycle times, fluid velocities, or fluid use of cleaning or rinsing cycles. Downward adjustments to fluid use can often reduce fluid or cycle time without detrimental impact to a product. Upward adjustments can improve rinsing, mixing, shelf life, and so forth, to improve outputs of a process, such as flavor, aroma, or consistency, removal of allergens or biofilms, or elimination of chemical residue. The adjustments can be performed based on existing sensors and actuators, or can be provided in combination with updated sensors or actuators. For example, the increased sensing granularity associated with updated sensors can aid the adjustments to the instructions. Because many processes include substantial margin in their operations (e.g., using predefined durations due to previously lower-sensitivity detection), the adjusted instructions can generally lead to net reductions in the usage of water, cleaning agents, or other system inputs, while maintaining or improving quality metrics of process outputs.

Updating control instructions in an automated liquid-processing environment can involve a number of challenges. These challenges can include, for example, determining acceptable detection limits for one or more process conditions, determining threshold or target values that trigger an update based on sensor data, and associating sensor outputs with human-machine interface devices to provide data to gauges, dashboards, reports, or other process outputs. Another technical challenge arises from the heterogeneity of variable definitions across systems, including inconsistent or non-standardized naming of process variables, sensor outputs, and calculated values. Such variability can complicate identification, mapping, and reuse of data across sensors, control logic, HMI elements, and higher-level analytics, particularly when instructions are updated, transferred, or scaled across different process lines or facilities.

According to the present disclosure, a data processing system can interface with at least one computational system to generate updated instructions. The computational systems can include a codebase of one or more variable names to relate data with corresponding parameters, functions, or stored values for processing, interpretation, or transformation. For example, a boiler temperature value may be received as a variable indicated as “boiler_temperature”, “boil_tmp”, “temp”, “bt”, “sig127”, or so on. The variable names can correspond to an organizational, industry, or other standard. Sometimes however, variable names are generated in an ad hoc fashion, in an absence or violation of any applicable standard. Computational systems can be integrated with various vendors, networks, organizations, or so forth. For example, PLC, distributed control systems (DCS), sensors, human-machine interfaces (HMI), Supervisory Control and Data Acquisition (SCADA) components, and other components of industrial controls can be configured to interoperate with one another. However, it may be difficult to identify or harmonize naming to provide input or output signals between devices, according to numerous possible conventions. For example, to confirm a variable meaning, an analyst may review the variable name as well as its contextual use in a codebase, as may include undertaking a static analysis of a codebase. Such analysis can prove time-consuming, and incorrect selections could lead to process issues or equipment malfunction.

Extraction-transformation-load operations are provided for codebases including unknown variables. Upon code extraction, instructions of a codebase can be ingested by a model (e.g., a large language model, LLM) to map the instruction variables to indications of their functions. Such mapping can include mapping the instruction variables to descriptive texts or predefined variables. For example, the LLM can include a model trained on various programmable logic codebases to determine a variable meaning based on variable names as well as any logical operations performed on or with the variables. The LLM can ingest a set of predefined variable names for the mapping. For example, for an integration using a boiler temperature, a boiler pressure, and a time remaining on a timer, the LLM can generate or ingest a set of three predefined variable names of “boiler_temperature”, “boiler_pressure”, and “process_time_remaining”, and map the variable names with names in the instructions, as may expedite the integration.

The integration can include providing or receiving information identified according to a variable name. For example, identification of the variable names can aid in the generation of output signals to cause their display on an HMI. Identification of the variable name can aid to input data associated with a variable. For example, an additional sensor can be provided to input a signal identified according to a variable name (e.g., the additional sensor can replace an existing sensor, or replace a calculated value with a sensed value). The integration can include changes to logical operations, or timed values. For example, the instructions can include instructions to advance a process prior to an expiration of a timer if a trigger is received (e.g., from an HMI), or other changes to a control process. The identification of the variables extracted from the codebase can ease integration, such as by aiding the integration of standard code blocks, or expediting review of the codebase.

The disclosed solutions have technical advantages for computing devices. For example, the data processing system can aid the reuse or factoring of a codebase according to standard conventions. Moreover, systems and methods of the present disclosure can optimize memory allocation, reduce redundant computations, and suggest performance improvements which may not be apparent in an obfuscated codebase. For example, the application of naming conventions can improve memory utilization and efficiency of automated auditing to detect redundant allocations, unused variables, and inefficient data structures. Accordingly, mappings or other identification of variables of instructions can be used to adjust the instructions to operate, to include improved efficiencies.

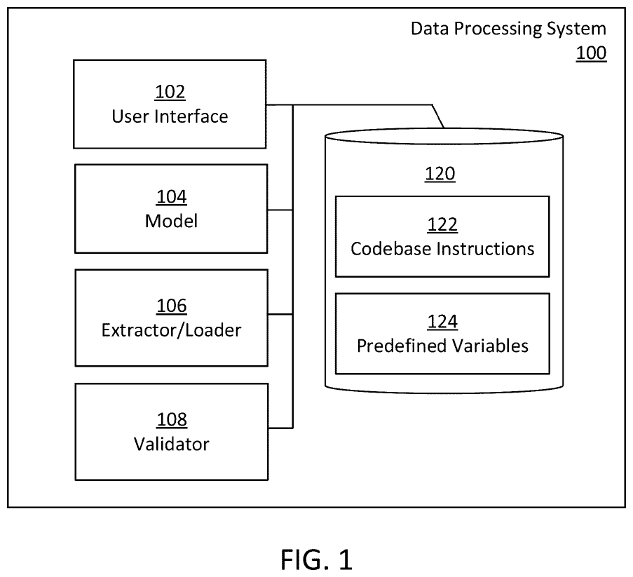

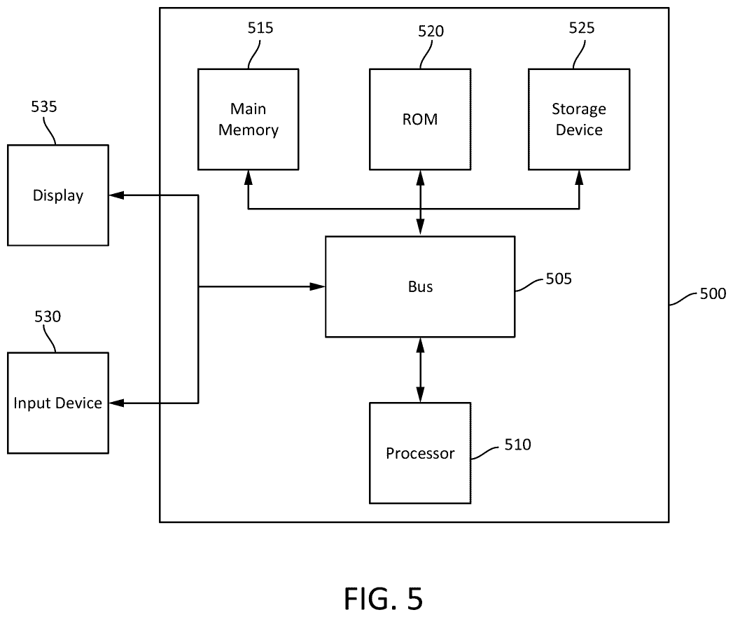

FIG. 1 depicts a data processing system 100, in accordance with some aspects. The data processing system 100 can include or interface with at least one user interface 102, model 104, extractor and loader 106, validator 108, or data repository 120. The user interface 102, model 104, extractor and loader 106, or validator 108 can each include at least one processing unit or other logic device such as a programmable logic array engine, or module configured to communicate with the data repository 120 or database. The user interface 102, model 104, extractor and loader 106, validator 108, or data repository 120 can be separate components, a single component, or part of the data processing system 100. For example, the data processing system 100 can include an ETL device to extract, transform, and update instructions of a programmable controller, and a control mechanism (e.g., HMI device, pushbutton, or other control) to interface with the programmable controller during operation. The data processing system 100 can include hardware elements, such as one or more processors, logic devices, or circuits. For example, the data processing system 100 can include one or more components or structures of functionality of computing devices depicted in FIG. 5.

The data repository 120 can include one or more local or distributed databases, and can include a database management system. The data repository 120 can be configured to receive updated data, such as codebases from a coupled programmable controller. The data repository 120 can include computer data storage or memory and can store one or more of codebase instructions 122, or predefined variables 124 corresponding to variables of the codebase instructions 122.

The codebase instructions 122 can refer to or include any instructions configured for execution by a programmable controller. For example, codebase instructions 122 can be depicted textually (e.g., structured text) or graphically (e.g., ladder logic). A programmable controller can refer to any controller having programmable instructions. For example, programmable controllers can include PLCs, DCS, or SCADA components. Codebase instructions 122 can include instructions to transmit data signals to actuate industrial controls, such as valves, switches, motors, conveyor belts, or actuators. Codebase instructions 122 can include instructions to transmit data signals to further controllers. For example, the further controllers can include HMI devices for display of the signals (or derivative signals), or further controllers of a DCS configured to transmit further derivative signals to actuate further industrial controls or to communicate data onward to further controllers still.

The codebase instructions 122 can implement control logic for industrial fluidic processes, based on comparisons between process sensor readings for a process fluid and one or more threshold values or transforms thereof. For example, temperature sensor inputs can be compared against a minimum activation temperature and a maximum pasteurization limit to determine whether heating jackets should be modulated. In a clean-in-place (CIP) cycle, a flow meter reading can be integrated over time to verify that a minimum cleaning solution volume has circulated, while turbidity sensor data can be differentiated over time to detect when rinse water achieves optical clarity. Based on these comparisons, the codebase instructions 122 can trigger actions such as opening a bypass valve, redirecting product to a holding tank, or engaging a relief path.

The predefined variables 124 can refer to or include a variable list for a particular organization or convention (e.g., a linted variable list). The predefined variable lists can apply across various codebases, and include signal names for processes, such as for batch processing of fluids, automated assembly, cleaning operations, or other industrial processes. The predefined variables 124 can be provided to the data processing system 100 to map with other variables, or the data processing system 100 can generate new variable names, or generate descriptions for existing variables, as may speed integration. In this way, variable names or descriptions can be generated, even where a set of predefined variables 124 is not provided.

By way of example, predefined variables 124 for use in industrial fluidic processes can include standard identifiers for components such as vessel pressure transmitters (“VESSEL_PRES”), outlet valves (“OUT_VALVE”), or water inlet lines (“WFI_SUPPLY_FLOW”). Some variables can capture computed or composite measurements such as temperature-compensated pH values, flow ratios between product and cleaning solution lines, or cumulative batch transfer volumes. These variables 124 can be used to implement functions such as controlling CIP sequences, triggering phase changes in multi-stage blending, or otherwise advancing through operations of the codebase instructions 122. However, mapping between the predefined variables 124 and instance-specific variables of a target system can prove challenging, according to a wide variance in implementation naming schemas, or a lack thereof.

The data processing system 100 can include at least one user interface 102 designed, constructed, or operational to convey information between the data processing system 100 and a user. The user interface 102 can include or interface with a graphical user interface (GUI) on a touchscreen or other display. The user interface 102 can include or interface with a user entry device such as a touchscreen, keyboard, API, or a web interface.

The user interface 102 can present controls to extract codebase instructions 122 from a programmable controller. Upon extraction, or other receipt (e.g., sideloading of the codebase instructions 122), the user interface 102 can display the codebase instructions 122. For example, textual instructions for temperature control can be provided as follows:

```
VAR
  tmpR_now, TmpSns, Tmpr_Set, TmpR_Tol : REAL;
  Heater_ON, sys_lockout : BOOL;
  tmr1 : TON;
END_VAR
tmpR_now := TmpSns;
IF tmpR_now >= (Tmpr_Set + TmpR_Tol) THEN sys_lockout:= TRUE; Heater_ON := FALSE;
END_IF
IF NOT sys_lockout THEN Heater_ON := TRUE; tmr1.IN := FALSE; END_IF
IF Heater_ON THEN tmr1.IN := TRUE; tmr1.PT := T#10S; END_IF
IF tmr1.Q THEN Heater_ON := FALSE; END_IF
```

It may be challenging to integrate with such a codebase, particularly, for complex logical functions. For example, it may be unclear whether TmpSns is a temporary signal, a temperature sensor, or another signal type without tracing other portions of the codebase. Moreover, duplicative local signal names are frequently instantiated in such codebases, as may increase memory usage unnecessarily.

To aid in review of the codebase instructions 122, the user interface 102 can generate descriptions for the variables, as can include variable names or other descriptions. The user interface 102 can receive or store one or more predefined set of reference variables 124. For example, each predefined set can correspond to at least one type or area of operational control system (e.g., heating ventilation and cooling, utilities, logistics, etc.). The user interface 102 can present a mapping of variables of the codebase instructions 122 and the predefined variables, as mapped by the model 104. For example, a mapping can be provided as follows:

| Codebase Instruction Variable | Predefined Variables |
|---|---|
| TmpSns | Temperature_Sensor_Input |
| Tmpr_Set | Temperature_Setpoint |
| tmpR_now | Current_Temperature |
| tmr1 | Heater_Shutdown_Timer |
| Heater_ON | Heater_Status |
| TmpR_Tol | Temperature_Tolerance |

The user interface 102 can further include control elements to adjust the codebase instructions 122, such as by substitution of variable names between the mapped variables, generation or modification of additional interfaces, or addition, removal, or modification of other functionality of the codebase. Such substitution can include changes to instructions of the codebase itself (e.g., as an integrated developer environment, IDE), or higher level code refactoring. For example, the user interface 102 can be configured to present or modify summaries or descriptions of code according to summaries or descriptions generated by the model 104 or received via the user interface 102. Although depicted as textual examples, the user interface 102 can display, generate, or modify various codebase types, including graphical displays for graphical modeling languages.

The data processing system 100 can include at least one model 104 designed, constructed, or operational to ingest, analyze, summarize, or modify codebase instructions. For example, the model 104 can ingest instructions of a programmatic controller and a set of predefined variables 124 to determine a match therebetween. For example, the model 104 can determine a contextual use of the variables of the codebase instructions 122 based on the variable name, other aspects of the programmatic functions, and non-executable portions of the codebase, such as comments, filenames, host device types, or other metadata.

The model 104 can include an LLM model to generate a map of correspondence between variable names of one or more text files including the codebase instructions 122 and the predefined variable names 124, another multimodal transformer model to generate a map of correspondence between variable names of one or more images and the predefined variable names 124, or further model types. The model 104 can be trained on further examples of instructions of further programmable controllers. The model can be trained on further matches with the predefined set of variables 124. For example, the training can include a provision of mappings between various codebase instructions 122 for various programmable controllers, as can include mapping selected by a user (through a corresponding user interface 102), selected by the programmable controller and confirmed by the user, or otherwise selected.

The model 104 can generate code changes based on a request received through the user interface 102. The code changes can include changes to variable names, as can reduce memory usage and improve readability. The code changes can include functional changes to the operation of the codebase instructions 122. For example, the code changes can generate an interface to couple with a control mechanism. The interface can include a logical port over which signals can be sent or received. For example, the control mechanism can include an HMI or other output device to output data based on a signal received from the programmable controller. The control mechanism can include an input device to provide a signal to the programmable controller. For example, the signal can trigger a change to the operating instructions, such as to abbreviate or extend a process time.

The model 104 can be trained on, ingest, create, or modify code for various operations. For example, such operations can include cleaning in place (CIP) suboperations for batch or other processes in food and beverage, pharmaceutical, wastewater treatment chemical, or other contexts. Operations can further relate to product quality, cooling optimization, filtration, CIP, changeovers, wastewater treatment, distillation, fermentation, reaction, emulsification, startup, viscosity control, quality control, active ingredient dosage, microbial risk, hygienic risk, food and safety risk reduction, filling lines, pasteurizing lines, product loss, bottling lines, product loading/unloading, product identification, ingredient dosage, process ingredient dosage, oil quality, raw material quality, water quality, chemical quality, chemical composition, blending, two phase flow/mixing, multi-phase mixing and blending, product to product transitions, crystallization, water treatment, chemical treatment, bioreactor operations, material separation, phase separation, production, wafer cleaning, medical device cleaning, semiconductor cleaning, semiconductor production, semiconductor etching optimization, etc.

The model 104 can generate recommendations on how to advance steps upon meeting conditions, as may extend or abbreviate a dwell time of the CIP suboperation. For example, the training data for the model 104 can include quality scores for implementation, such that a generated recommendation can increase a quality score for process instructions generated according to the present systems and methods. The model 104 can suggest changes to a timing or quantity of dispensed substance, as a part of the batch process or CIP suboperation. The model 104 can generate a new instance of codebase instructions 122, as in the case of a new programmable controller or a migration from another type of programmable controller (e.g., generate code for a first controller or language based on instructions of another controller).

The data processing system 100 can include at least one extractor or loader 106 designed, constructed, or operational to obtain codebase instructions 122 configured to effectively use a programmable controller. For example, the obtained codebase instructions 122 can include instructions to execute various processes. The extractor or loader 106 can receive the codebase instructions 122 as text files, image, or other formats.

The extractor or loader 106 can update the codebase instructions 122 of a programmable controller. For example, the extractor or loader 106 can transfer updated instructions to the programmable controller, and cause the programmable controller to boot from, load, or otherwise execute the updated instructions. The updated instructions can include instructions updated via the user interface 102 or the model 104. The updates can include updates to variable names to accord to a standard or convention, as can ease integration. The updates can include functional changes related to the execution of the codebase instructions 122, such as by providing additional input or output signals, changes in sequence triggers or times, or so forth.

The extractor or loader 106 can interface with a validator 108 to provide results of functional or structural validation back to the model 104 for refinement of variable mappings or code changes. The extractor and loader 106 can implement these refinements in updated instructions, for correctness, standards compliance, or resource efficiency according to an iterative or one-shot process.

The data processing system 100 can include at least one validator 108 designed, constructed, or operational to validate the operation or structure of codebase instructions 122. For example, the operation of the codebase instructions 122 can refer to simulated operation of the instructions, or detected operation of a system including various control devices coupled with a programmable controller. The structure of the codebase instructions 122 can refer to the syntax, organization, re-used elements, or other aspects of the structure of the code.

Referring further to the detected operation of the system, the validator 108 can operate in a hardware in the loop (HIL) mode to execute the codebase instructions 122 in conjunction with a target system. For example, the target system can include sensors, actuators, or other control devices, supplying the validator 108 with real-time or test input conditions and corresponding outputs. The validator 108 can compare received data to data corresponding to signal loss, invalid ranges, step changes of the instruction (e.g., a change of state of a state machine, a change of a counter position, or so forth). The simulated execution can generate timelines of variable changes, control outputs, and execution sequences, aiding analysis of timing behavior and functional correctness.

Referring to the simulated operation of the instructions, the validator 108 can execute the codebase instructions 122 within a virtualized representation of the programmable controller and its associated control devices, without at least a portion of the physical hardware. The simulated execution mode can use mathematical plant models, process state data, or previously recorded operational traces. The simulated environment can incorporate historical process data or recorded operational scenarios. The validator 108 can programmatically vary input conditions to assess behavior under nominal and off-nominal situations, including startup, steady-state operation, transient events, advancement through steps of a sequence, or shutdown states. The simulated operation can validate that steps of a sequence are performed as intended (e.g., that no states are skipped, or that the process does not dwell or loop within a state). The data processing system 100 can implement changes to codebase instructions 122 according to a staged implementation whereby changes to one operation are validated to confirm a lack of impact on other operations.

In the simulated operation or HIL modes of execution, the validator 108 can compare values to nominal or absolute ranges to identify off-nominal operation. Off-nominal operation can refer to actual operation or to anomalous reporting of values. Some examples of off-nominal actual operation can include pressures, temperatures, volumes, or flow rates that reflect actual operation of a system but that are not within expected values, such as a fluid which is overheating by several degrees. Anomalous reporting of values can include type casting errors such as sign or scale errors, treatment between float and integer values, endianness, one's and two's complement, or so forth.

Referring to the validation of the structure of the codebase instructions 122, the validation can refer to or include a validation of adherence to coding guidelines. The adherence can include the use of modular functions to reduce risk of changes, as can reduce the file size of stored executable instructions. Moreover, such an approach can aid review of any changes to be implemented, since functions can be atomically evaluated, and then confirmed according to their location in a codebase (e.g., once validated, instantiating multiple instances of a function can ease code review). The reused functions can include existing code of a codebase to manage change to existing codebase. For example, functions used to open or close valves, fill or empty tanks, adjust pressures or temperatures, and so forth can be implemented modularly. These modules can include corresponding checks of upstream or downstream systems related to a function, actuation of indicator lamps, and other aspects of system operation.

The reused functions, or other aspects of the codebase instructions 122 can include functions generated by a model 104 of the data processing system 100. For example, the model 104 can generate code adhering to global or codebase specific guidelines to improve the maintainability of code, and ease review or other validation operations performed by the data processing system. The code generated by the model 104 can include code generated in response to a query via a user interface 102 of the data processing system 100. For example, in response to receiving human-readable text via a web-based or other application input of the user interface 102, the data processing system 100 can cause the model 104 to generate codebase instructions 122 to implement the human-readable text.

Inputs to the data processing system 100 can include limits for sequences, cycle times, advancement criteria, or other aspects of the instructions. For example, a process can include a state machine or other discrete modes of operation having a variable duration (e.g., a duration of a wash, rinse, settle, or mix cycle of a chemical process). The limits can include minimum or maximum durations, orders or sequences (e.g., that an advancement from ACT 4 to ACT 6 of an operation should not occur without an intermediate ACT 5). The data processing system can execute objective functions based on the received limits. For example, an objective value of a parameter of the objective function can be provided as zero or infinity for values violating a limit, such that other parameters of the objective function can be optimized based on the limits as a priori knowledge, where optimization refers to determination of a local minimum or maximum which may (but need not) operate as a global optimum.

The validator 108 can detect and quantify inefficiencies in the codebase instructions 122, such as unused variables, redundant computations, or unnecessary polling of input and output devices. The data processing system 100 can remove unused variables to reduce memory footprint, restructure logic to minimize processor cycles, and adjust communication schedules to reduce network transactions between the programmable controller and connected devices. Such optimization can improve execution speed, decrease resource utilization, and extend the operational lifespan of controller hardware by lowering computational load.

The validator 108 can be implemented separately from a programmable controller configured to interface with various control devices of a system. For example, the validator 108 can include a gateway or web server in network communication with the programmable controller, or otherwise configured to receive information of a state of a monitored system to receive real-time or historical traces of a condition of the system.

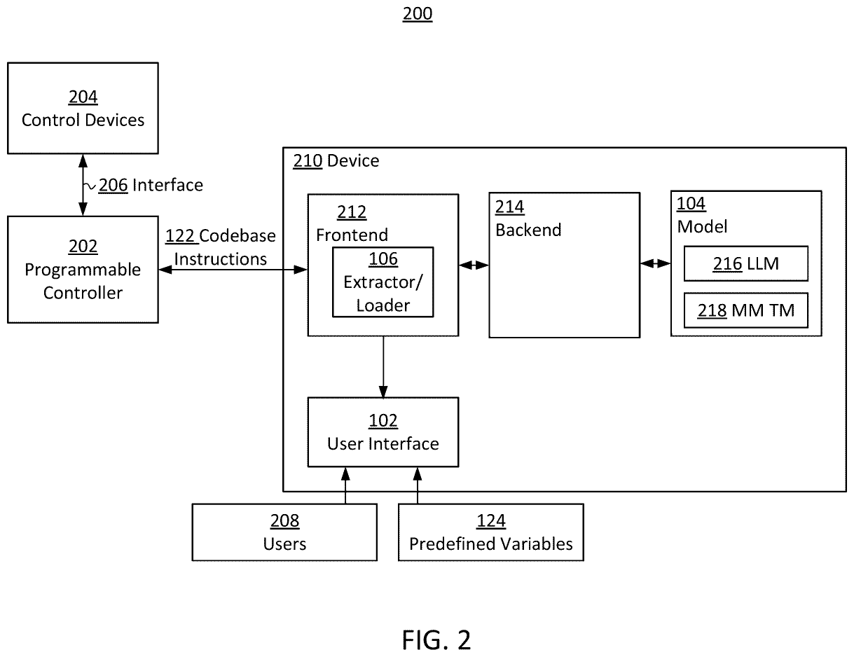

FIG. 2 depicts a dataflow 200 for the data processing system 100 of FIG. 1, in accordance with some aspects. The dataflow includes a programmable controller 202 storing codebase instructions 122 to interface with various control devices 204 (e.g., HMI devices, valves, actuators, conveyers, relays, or so forth). An operative connection between the programmable controller 202 and the control device can be referred to as an interface 206, as can include digital input or output, serial connections, Ethernet or other network interfaces, or other operative connections. The programmable controller 202 is operably coupled with one or more devices 210 of a data processing system 100. For example, the device 210 can include an extractor or loader 106 to receive codebase instructions 122 including variable names, and provide updated codebase instructions 122. The updates can include updates to match descriptions for variables such as a set of predefined variable names 124 stored locally on the device 210 or received from another source, such as via a user interface 102. The updates can include functional changes. For example, the updates can include changes to codebase instructions 122 received by a user, or from a model 104.

The device 210 can instantiate or interface with a model 104. For example, a frontend application 212 of the device 210 can interface with the model 104 according to an operative connection, as can include components of a backend 214 of the device 210. For example, as is depicted, the model 104 can include an LLM 216 to interpret or modify textual code, a multi-modal transformer model 218 to interpret or modify image-symbolic code, and so forth. The models 104 can be locally instantiated or remotely accessed.

The backend 214 can store or access thresholds of the industrial fluidic process, such as maximum allowable vessel pressure, minimum sterilization temperature, target flow ranges, or permissible dwell times between process stages. The data processing system 100 can use these values to formulate specific requests to the model 104. For example, when generating code adjustments, the backend 214 can provide the model 104 with boundary conditions and thresholds so that any recommended changes remain compliant with process specifications.

The device 210 can source updates to the codebase instructions 122 from inputs received from a user 208, or an output generated by the model 104. Moreover, the device 210 can provide, via the user interface 102, summaries of the codebase instructions 122, as can prompt the user to provide requested updates. The requested updates can include manual entries to modify the codebase instructions 122, or summaries of changes, as can be ingested by the model 104 to generate updated codebase instructions 122 including the requested changes.

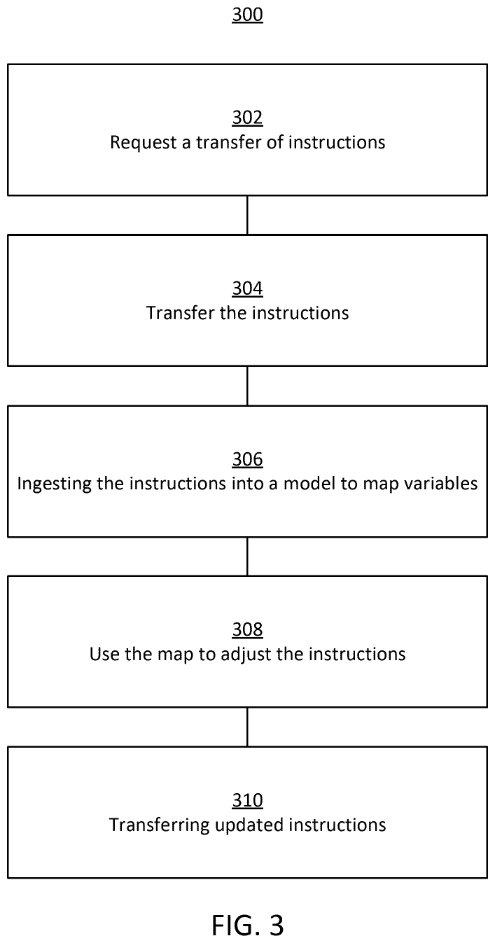

FIG. 3 is a dataflow for a method 300, according to some aspects. The method 300 can be performed by one or more processors, as can be used to implement the data processing system 100 of the present disclosure. The present method 300 should not be construed to limit the present disclosure. For example, operations of the method 300 can be modified, substituted, omitted, or added, according to the various aspects of the present disclosure.

At ACT 302, the data processing system 100 can request, from a programmable controller 202, a transfer to and storage in a memory of the device, of instructions configured for effective use of the programmable controller 202. For example, the instructions can cause the programmable controller 202 to operate with various control devices over one or more interfaces 206. The instructions can, for example, include a sequence of operations and criteria for advancement between the sequenced operations. For example, the thresholds can include thresholds to continue delivering a fluid, processing a fluid (e.g., heating, cooling, pressurizing, or mixing), advancing to another operation, aborting an operation (e.g., venting a pressure vessel or opening a valve to an overflow reservoir).

The data processing system 100 can receive various components from various corresponding sources. For example, the data processing system 100 can implement an interface 206 to communicatively couple with the programmable controller 202 via an Ethernet, serial, or other interface 206, or receive instructions via a user interface 102.

At ACT 304, the data processing system 100 can transfer and store the codebase instructions 122 into a memory. For example, the memory can include a local memory of a device coupled with at least one model 104. The data processing system 100 can receive the instructions according to various formats or languages, such as ladder logic, structured text (ST), sequential function charts, c, c++, or various graphical scripting environments. For example, the data processing system 100 can receive the instructions as a text file having strings as variable names or as an image for a graphical modeling language.

At ACT 306, the data processing system 100 can ingest the codebase instructions 122 into the model 104 to generate a mapping between variables of the instructions and a description of their function. For example, the data processing system 100 can ingest the text file of ACT 304 and a predefined set of reference variables 124 into a large language model (LLM) of the model 104 to generate the mapping. The large language model can be trained on instructions for various further programmable controllers 202. Such training can aid the model 104 to identify contextual use of the variables, and map them to the predefined set of variables 124, where provided. The data processing system 100 can ingest the image of ACT 304 and the predefined set of reference variables 124 into a multimodal transformer model of the model 104 to generate the mapping. The multimodal transformer model can be trained on instructions for various further programmable controllers 202. Such training can aid the model 104 to identify contextual use of the variables, and map them to the predefined set of variables 124 or other descriptors. The model (e.g., the LLM or the multi-modal transformer model) can receive a current process state from a process state display, as may aid matching variables, temperature, and so forth (e.g., by matching variables to names or temperatures). The model 104 can use the process state display to generate further displays, provide additional information to a display type (e.g., augment a received process state display), or identify sensors. The model 104 can further ingest instruction change requests, such as additional input or output signals, or interfaces 206. For example, the change requests can change times for process portions, or instructions to extend or terminate process suboperations based on sensor data, or other inputs of a control mechanism.

At ACT 308, the data processing system 100 can use the mapping to adjust the instructions to operate based on an interface 206 with a control mechanism. For example, the updated instructions can provide input or output signals for the programmable controller 202 to adjust operation based on a receipt of an input from the control mechanism. The data processing system 100 can further present any changes (e.g., a summary thereof) to the user interface 206. For example, the data processing system 100 can present the mapping via the user interface 206 along with a selectable control element. Upon actuation, the selectable control element can accept or modify a correspondence between a first reference variable of the predefined set of reference variables 124 and a first variable of the instructions, or according to other descriptor schemas.

At ACT 310, the data processing system 100 can transfer control of the programmable controller 202 to the updated instructions by transferring the updated instructions to the programmable controller 202. For example, the updated instructions can include an updated variable name or other operational change to the instructions. The transfer of control can refer to an execution of the updated instructions by the programmable controller 202. Upon the transfer, the control mechanism can provide, over the interface 206, a signal (e.g., the control mechanism can provide a trigger over the interface 206 to advance from a process prior to its scheduled completion). The programmable controller 202 can modify execution of the instructions responsive to receipt of the signal, such as by extending or abbreviating a timed process. For example, the control mechanism can include an HMI, a sensor, or another programmable controller 202.

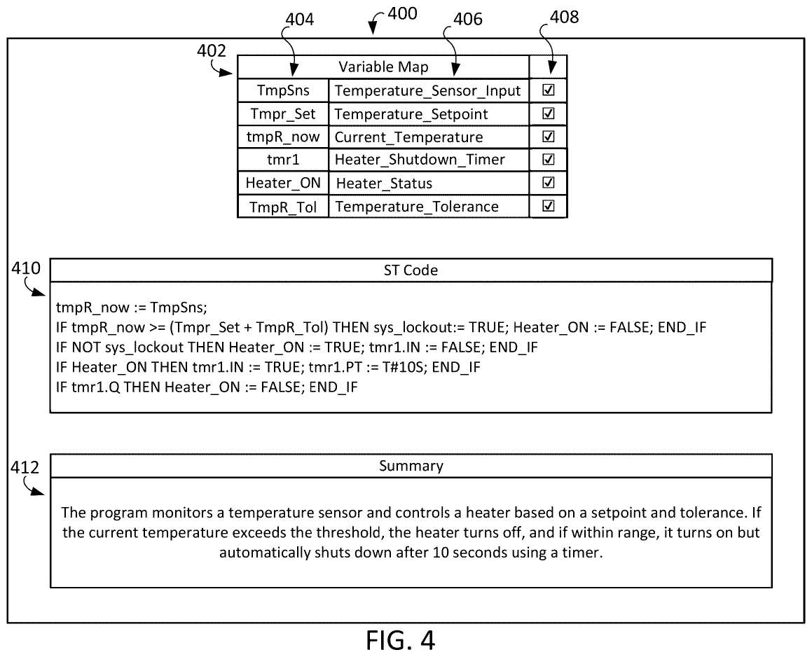

FIG. 4 depicts an example of a graphical user interface (GUI) 400 generated or presented by the user interface 102, according to some aspects. The GUI 400 can present a variable mapping 402 including a mapping between variable names 404 of received instructions and variable names 406 of a predefined set or other descriptors, as may be generated by the model 104. Selectable control elements 408 are provided to select a substitution of the variable names of the map 402. The variable names can further be selectable to manually change naming. The GUI 400 can include a depiction of any received instructions 410 and a summary 412 of the received instructions.

The fields can be selectable to adjust the instructions. For example, the codebase instructions can be edited manually or based on a summary of requested changes. Responsive to a receipt of a requested change, the GUI 400 can recommend an insertion point for the change within the codebase instructions 122. For example, the GUI 400 can present an indication of a location for the change, a refactoring proposal (e.g., an addition of a branch condition triggered based on a detected condition, such as a comparison of a value to a threshold). The GUI 400 can further receive open form text queries via the user interface, and provide the queries to the model 104. The GUI 400 can present outputs based on the queries, as can include modifications to the codebase instructions 122, a new codebase, information relating to the existing codebase (e.g., an identification of any key values, variable, signals, or other aspects of the codebase instructions 122). Such queries can be used to cause the model 104 to provide information relating to codebase instructions 122, or to update the codebase instructions 122. For example, a first set of queries can identify more particular information about the codebase instructions 122, based on which a user can request updates to the codebase instructions 122.

The user interface 102 can receive indications of in the loop operation, such as signal states, device positions, temperatures, and so forth. The user interface 102 can receive queries related to explanation of a current state such as troubleshooting or debugging of a system. The data processing system 100 can review previously ingested historical patterns, deviations, or alert triggers to identify a cause. For example, a query can include a question as to why a process suboperation took longer to advance than historical examples. The user interface 102 can provide a summary and root cause, such as a temperature failing to meet a threshold to trigger a process from a first and second operation. The user interface 102 can further provide an indication of a cause, such as additional material, a decreased temperature of a material as received, or a heater operating at below full capacity. In some cases, the indication of the cause can include potential physical or codebase changes as can reduce the deviation from the historical examples.

FIG. 5 is a block diagram illustrating an architecture for a computer system 500 that can be employed to implement elements of the systems and methods described and illustrated herein. The computer system or computing device 500 can include or be used to implement a data processing system 100 or its components, and components thereof. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random-access memory (RAM) or other dynamic storage device, coupled to the bus 505 for storing information, and instructions to be executed by the processor 510. The main memory 515 can be used for storing information during execution of instructions by the processor 510. The computing system 500 can further include at least one read only memory (ROM) 520 or other static storage device coupled to the bus 505 for storing static information and instructions for the processor 510. A storage device 525, such as a solid-state device, magnetic disk or optical disk, can be coupled to the bus 505 to persistently store information and instructions (e.g., for the data repository 120).

The computing system 500 can be coupled via the bus 505 to a display 535, such as a liquid crystal display, or active-matrix display. An input device 530, such as a keyboard or mouse can be coupled to the bus 505 for communicating information and commands to the processor 510. The input device 530 can include a touch screen display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement can also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a subject can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system to update instructions for industrial fluidic processes based on sensor inputs, the system comprising one or more processors coupled with memory to extract, transform, and load instructions of a programmable controller to control the industrial fluidic processes, the one or more processors to:
request a transfer to and storage of the instructions into a memory of a device;
transfer and store the instructions into the memory;
ingest the instructions into a model to generate a mapping between variables of the instructions and a description of their function;
use the mapping to adjust the instructions to operate based on an interface with a control mechanism; and
transfer control of the programmable controller to the updated instructions by transferring the updated instructions to the programmable controller.

2. The system of claim 1, comprising:
an extract-transform-load (ETL) device to extract, transform, and update the instructions to generate the updated instructions; and
the control mechanism, wherein the control mechanism is to control a flow of a fluid based on sensor data received by the ETL device.

3. The system of claim 1, comprising the one or more processors to:
receive the instructions as a text file having strings as variable names; and
ingest the text file into a large language model (LLM) of the model to generate the mapping, wherein the LLM is trained on instructions for a plurality of other programmable controllers.

4. The system of claim 1, comprising the one or more processors to:
receive the instructions as an image for a graphical modeling language; and
ingest the image into a multimodal transformer model of the model to generate the mapping, wherein the multimodal transformer model is trained on images comprising variable names and logic elements of other programmable controllers.

5. The system of claim 1, comprising the one or more processors to:
receive a signal from the control mechanism via the interface, wherein the control mechanism is one of a human machine interface (HMI) or a second programmable controller; and
modify execution of the instructions responsive to the receipt of the signal.

6. The system of claim 1, comprising the one or more processors to:
provide a trigger to advance from a process prior to its scheduled completion over the interface.

7. The system of claim 1, comprising the one or more processors to:
ingest a request to adjust the instructions into the model; and
receive, from the model, the adjusted instructions to operate based on the interface with the control mechanism.

8. The system of claim 1, comprising the one or more processors to present, via a user interface of the device:
the mapping; and
a selectable control element to accept or modify a correspondence between:
a first reference variable of a predefined set of reference variables; and
a first variable of the instructions.

9. The system of claim 1, comprising the one or more processors to:
compare a duration or state transition of a previous execution of the instructions to a behavior of the control mechanism using the updated instructions to validate the updated instructions.

10. The system of claim 9, wherein the behavior of the control mechanism is a simulated behavior and the validation is executed prior to transferring the updated instructions to the programmable controller.

11. A method for extraction, transformation, and loading of instructions of a programmable controller, the method comprising:
requesting, by a device remote from the programmable controller, a transfer to and storage in a memory of the device, of the instructions configured for effective use of the programmable controller;
transferring and storing of such instructions into the memory;
ingesting the instructions into a model to generate a mapping between variables of the instructions and a description of their function;
using the mapping to adjust the instructions to operate based on an interface with a control mechanism; and
transferring control of the programmable controller to the updated instructions by transferring the updated instructions to the programmable controller.

12. The method of claim 11, comprising:
receiving the instructions as a text file having strings as variable names; and
ingesting the text file into a large language model (LLM) of the model to generate the mapping, wherein the LLM is trained on instructions for a plurality of other programmable controllers.

13. The method of claim 11, comprising:
receiving the instructions as an image for a graphical modeling language; and
ingesting the image into a multimodal transformer model of the model to generate the mapping, wherein the multimodal transformer model is trained on images comprising variable names and logic elements of other programmable controllers.

14. The method of claim 11, comprising:
receiving a signal from the control mechanism via the interface, wherein the control mechanism is one of a human machine interface (HMI) or a second programmable controller; and
modifying execution of the instructions responsive to the receipt of the signal.

15. The method of claim 11, comprising presenting, via a user interface of the device:
the mapping; and
a selectable control element to accept or modify a correspondence between:
a first descriptor; and
a first variable of the instructions.

16. The method of claim 11, comprising:
updating a variable of the instructions to match a corresponding one of the variables.

17. A non-transitory computer readable medium, comprising:
one or more instructions stored thereon and executable by a processor to:
request a transfer to and storage of the instructions into a memory of a device;
transfer and store the instructions into the memory;
ingest the instructions and a predefined set of reference variables into a model to generate a mapping between variables of the instructions and the predefined set of reference variables;
use the mapping to adjust the instructions to operate based on an interface with a control mechanism; and
transfer control of a programmable controller to the updated instructions by transferring the updated instructions to the programmable controller.

18. The non-transitory computer readable medium of claim 17, comprising:
one or more instructions executable by the processor to:
receive the instructions as a text file having strings as variable names; and
ingest the text file and the predefined set of reference variables into a large language model (LLM) of the model to generate the mapping, wherein the LLM is trained on instructions for a plurality of other programmable controllers.

19. The non-transitory computer readable medium of claim 17, comprising:
one or more instructions executable by the processor to:
receive the instructions as an image for a graphical modeling language; and
ingest the image and the predefined set of reference variables into a multimodal transformer model of the model to generate the mapping, wherein the multimodal transformer model is trained on images comprising variable names and logic elements of other programmable controllers.

20. The non-transitory computer readable medium of claim 17, comprising one or more instructions executable by the processor to:
present, via a user interface of the device:
the mapping; and
a selectable control element to accept or modify a correspondence between a first reference variable of the predefined set of reference variables and a first variable of the instructions.
